(19) United States
(12) Patent Application Publication
(10) Pub. No.: US 2015/0339795 A1
(43) Pub. Date: Nov. 26, 2015

(54) Portable Nutrition Bar and Method of Diseminating Information Using Portable Nutrition

(71) Applicant: Owen Sortwell, Niwot, CO (US)

(72) Inventor: Owen Sortwell, Niwot, CO (US)

(21) Appl. No.: 14/720,203

(22) Filed: May 22, 2015

Related U.S. Application Data
(60) Provisional application No. 62/002,493, filed on May 23, 2014.

(51) Int. Cl. G06Q 90/00; A23L 1/302; A23L 1/30; A23L 1/308; A23L 1/305; A23L 1/29; A23L 1/303

(52) U.S. Cl. CPC G06Q 90/00; A23L 1/296; A23L 1/302; A23L 1/303; A23L 1/308; A23L 1/305; A23L 1/3006; A23V 2002/00

(57) ABSTRACT

A method of disseminating information to a target group can include selecting a target group, selecting information for the target group, and providing a nutrition bar having a wrapper comprising the selected information. The information can be selected to include telephone numbers and/or location of publicly available services for the target group, for example, when the target group is homeless individuals. The nutrition bar can provide at least ⅓ of the recommended dietary allowance of at least one nutrient.

### FIELD OF THE DISCLOSURE

This application claims priority benefit of U.S. Provisional Application No. 62/002,493 filed May 23, 2014, the disclosure of which is incorporated herein by reference in its entirety.

### BACKGROUND

### Brief Description of Related Technology

In 1941, the first RDAs were published after being created by the Food and Nutrition Board of the National Academy of Sciences. It has long been known that good nutrition is essential for good health, but no one really knew how much of different types of nutrients a person needs in a day until research was conducted showing specific requirements for men, women and children. Since the first time the RDAs were published, they have been updated ten times as new research has been conducted and lifestyles have changed. Most recently, in 1995, the Food and Nutrition Board concluded that a more detailed system was required to offer better guidelines. This system is called the Dietary Reference Intakes (DRIs). It still includes RDAs but also contains the “Adequate Intake” (Al) when they can't completely establish an RDA, “Tolerable Intake Level” (UL) which is the highest safe amount of an nutrient that someone should have, and the “Estimated Average Requirements” (EAR) which is the estimated amount of nutrients needed by half of all the healthy individuals in the population. The DRIs are also broken down into more groups, like different age groups for children, teenagers, adult men and women all the way to old age, and pregnant women. However, it is still recommended that people focus on RDAs as the most important guideline for average daily intake for the entire population.

Homelessness makes it extremely difficult for a person to get all the nutrients needed to meet the RDAs in a day. In fact, ⅓ of people living in homeless shelters only get ⅔rds of the calories they need in a day, not to mention vitamins and minerals. Unfortunately, soup kitchens rely on food and money donations and cannot make RDAs their priority. Many people who experience chronic homelessness do not have access to soup kitchens and those who do may not go to one because of mental illness, alcoholism or feelings of shame. In the late 1990s, a study of 87 people who were chronically homeless and lived outdoors, found that they averaged 500 fewer calories than the RDAs, and among men, 44% of the calories they consumed were from alcohol. Recently, more studies have been done that reveal how seriously malnutrition affects the health of people who are homeless. One man experiencing chronic homelessness was treated for serious health conditions in 2001 after surviving on potato chips and soda for six months. However, after receiving proper nutrition for a period of time, his health problems disappeared. This example shows just how much nutrition can matter to the health of people who are homeless.

In 2010, Sacramento, Calif., conducted a survey of 112 people who were homeless; 83% reported health issues like acid reflux, hypertension, and diabetes. The study concluded that these health conditions were made far worse by lack of proper nutrition. Under-nutrition has been associated with anemia, dental problems, gastric ulcers and other gastro-intestinal problems, complaints of cardiovascular disease, hypertension, hypercholesterolemia, acute chronic infectious disease, diabetes, and wasting disease involving muscles. People who experience homelessness are often deficient, not only in calories, but also in calcium, zinc, vitamin B6, thiamin, vitamin A, and riboflavin. Those who smoke are much more likely to be vitamin C deficient. Additionally, obesity is a significant problem amongst the homeless population. A 2012 study showed that over ⅓ of the homeless population is obese. This is due to consumption of the “empty calories” that are most frequently available. Clearly the data supports the need for creative ways to supplement the nutritionally inadequate foods that people who are homeless consume. Doing this would significantly reduce health problems. A supplemental nutrition bar could efficiently provide vital help.

### SUMMARY OF THE DISCLOSURE

In accordance with an embodiment of the disclosure, a portable nutrition bar for disseminating information to a target group can include an edible nutrition bar containing at least ⅓ of the recommend dietary allowance or one or more nutrients, and a wrapper comprising information for selected for the target group, wherein the information is not nutritional information of the edible nutrition bar.

In accordance with an embodiment of the disclosure a method of disseminating information using portable nutrition can include selecting a target group, providing a portable nutrition bar encased in a wrapper, wherein the wrapper comprises selected information for the target group.

In accordance with another embodiment of the disclosure, a method of assistant a target group can include providing the target group with a nutrition bar that provides essential nutrition in a convenient and portable manner, while conveying on its wrapper useful service information for that target group. The nutritional value of the bar can advantageously promote the continued use of such bars, which promotes continued exposure to the information provided on the bars.

Embodiments of the disclosure can advantageously provide a nutrition bar that is portable. For example, the bars can be carried in police car trunks, be available in shelters and be given out by people in the community. The bars can be sized to easily fit in a pocket and can be eaten anywhere. Someone in the target group, for example, a person experiencing homelessness, can have three bars and get the nutrients they need in a day in addition to being presented with useful service information for the target group. The bars can have a long shelf life, and can be provided in a weatherproof wrapper. Unlike a soup kitchen meal where an individual in the target group of homelessness must wait in line and sit with a lot of people and might be too scared or unwilling to do this, or can't show up at the right time for a meal, the bars are portable and can be carried with the individual, increasing exposure of the individual to the service information.

### BRIEF DESCRIPTION OF THE DRAWINGS

FIG. 1 is a front view of a portable nutrition bar in accordance with an embodiment of the disclosure.

FIG. 2 is a rear view of a portable nutrition bar in accordance with an embodiment of the disclosure.

### DETAILED DESCRIPTION

The portable nutrition bar and methods in accordance with the disclosure advantageously provide a means for disseminating information to a target group using an instrument that is likely to be retained by the target user. For example, in the case of a homeless individual, the portable nutrition bar can be enclosed in a wrapper containing information regarding helpful services for that target individuals, including but not limited to information regarding food banks, shelters, and mental health services. As compared to conventional forms of disseminating information, such as flyers and cards, which are readily discarded by individuals, the portable nutrition bars of the disclosure are more likely to be retained by the individual and reviewed for such information because the bar provides the individual with essential nutrition. One or more of the bars can be advantageously retained by the individual for extended periods of time and can be used by the individual as needed, for example, as a meal replacer. Upon each use, the individual will be exposed to the information contained on the wrapper of the bar and may be more likely to seek out such services because of such repeated and continuous exposure.

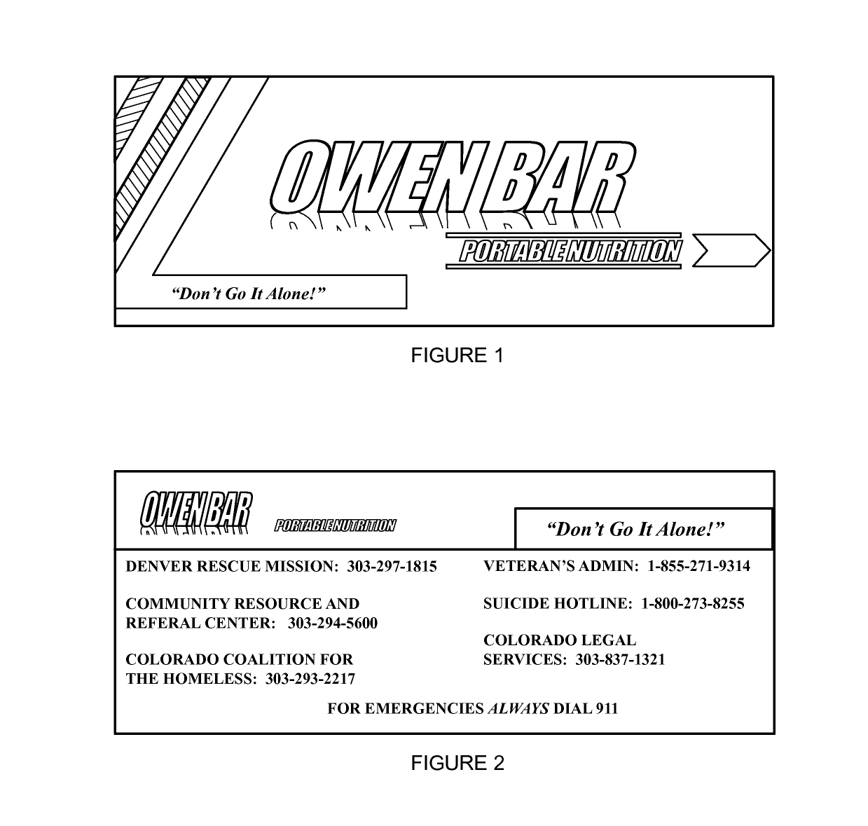

Referring to FIGS. 1 and 2, the wrapper can be a weatherproof wrapper that allows the individual to retain the product for an extended period of time and maintains the information in a clear and readable manner. The information provided on the wrapper can be tailored for the target group. For example, where the target group is homeless individuals the wrapper can include information regarding the number and address of local shelters, clinics, substance abuse assistance, abuse centers such as battered women assistance centers, legal services, child advocacy services, veterans services, job placement services, family assistance services, and other resources that would be useful to such individuals. The bars are portable and can be easily disseminated by community workers, including police, fireman, soup kitchens, volunteers, and others having contact with the target group.

For example, the target group can be individuals facing an emergency, for example, a natural disaster. The bars can be kept by people in their homes and/or disseminated by emergency workers, for example, Red Cross, FEMA, fireman, police offices, and other such workers. For such a target group, the bars can include the telephone number of emergency contact personal, the location of nearest hospitals, and/or the telephone number and location of emergency shelters.

In accordance with another embodiment of the disclosure, the bars can be for a target group of natural disaster victims and can include information useful for such individuals in surviving a natural disaster or other emergency situation. For example, the wrapper of the bars can be printed with information about safe places to be located during a given natural disaster, such as a tornado. The bars not only provide such useful information, but are portable and easily kept with the individual to provide needed nutrition that may not be readily available after a natural disaster, particularly if the individual carrying the bar becomes trapped or otherwise must await assistance.

In yet another embodiment, the nutrition bars can be useful for individuals camping, hiking, canoeing, hunting, and the like. The bars can provide needed nutrition during such ventures and, in particular, in the case of emergency that may occur and require that an individual await assistance. In such examples, the wrappers can include tips for places to shelter in a given environmental location, such as a mountain, tips for addressing first aid issues when medical assistance is not readily available, and/or the telephone numbers of local rangers' offices or assistance centers.

The nutrition bar can be designed to meet ⅓ of some of the most important RDAs for an adult, including one or more of calcium, fiber, carbohydrates, protein, fat, vitamins A, C, D, E, K, B1 (thiamine), B2 (riboflavin), B3 (niacin), pantothenic acid, Biotin, vitamins B6 and B12, and folate (folic acid) The bar can be designed to meet at least ⅓ of the caloric requirements for a day based on the 2,000 calories a day most adults require. In one embodiment, the bar is designed to meet ⅓ of the caloric requirement for a day for the average adult. The bars can also be designed to meet the requirements for children, elderly, pregnant women, teens, and other groups. This means that a person who is homeless could supplement his meals at a soup kitchen by eating one or two bars in a day, or could eat three bars in a day and get the necessary key nutrition.

The nutrition bars can include a variety of ingredients to provide the RDA requirements from national sources. For example, the bars can include one or more of peanut butter, almond butter, powdered sugar, honey, graham crackers, crispy rice, chocolate, oats, grains, nuts, seeds such as sesame seeds or Chia seeds, and dried fruit. The bars can further include preservatives for improved shelf life and various micronutrients and supplements depending on the bars target group.

The nutrition bar can be sized to be portable. For example, the bar can be sized to fit within a standard clothing pocket. In accordance with an embodiment the bar can have a length of about 1.5 inches to about 5 inches, about 2 inches to about 3 inches, or about 2 inches to about 4 inches. For example, the bar can have a length of about 1.5, 1.75, 2, 2.25, 2.5, 2.75, 3, 3.25, 3.5, 3.75, 4, 4.25, 4.5, 4.75, or 4 inches.

The bars can have a width of about 1 inch to about 3 inches, about 1.5 inches to about 2 inches, about 2 inches to about 3 inches, or about 1.25 inches to about 2 inches. Other suitable widths include, for example, about 1, 1.25, 1.5, 1.75, 2, 2.25, 2.5, 2.75, and 3 inches.

The bars can have a thickness of about 0.5 inches to about 2 inches, about 0.75 inches to about 1.75 inches, about 1 inch to about 2 inch, or about 0.5 inches to about 1 inch. Other suitable thicknesses include about 0.5, 0.75, 1, 1.25, 1.5, and 2 inches.

In one embodiment the bars have a length of about 3.25 inches, a width of about 1.635 inches, and a thickness of about 1.5 inches. Other suitable dimensions are also contemplated herein. For example, for ease of use by a target group, the bars can be designed to be consumed in a single bit.

The bars advantageously have a taste and texture that is pleasing to the individual, while providing essential nutrition needed by that individual. This promotes the use and carrying of the bars by the individual for continued use, which in turn beneficially exposes the individual to the information contained on the bar for longer periods of time. Extended exposure to such information may encourage the user of the bar to seek out the beneficial services. Further, the locations of the services listed on the bar can also beneficially provide additional bars to the individual, which could not only promote better nutrition for that individual, but also prompt the individual to visit a shelter or clinic in order to obtain additional bars and potentially further prompt that individual to engage in the helpful services of that facility.

### Example

In accordance with an embodiment of the disclosure, a nutrition bar was made with the following ingredients:
2 C sugar
3 T cocoa
½ C butter
½ C 2% milk
½ C Jif creamy peanut butter
2 Cups Sunbelt Bakery Low Fat Granola: “whole grain cereal with cinnamon, raisons, and almonds”—all raisons removed before using in recipe=2 T removed for a batch (there are a total of 6 T contained in an entire box).
1 C Kellogg's All-Bran Original
2 T honey

The nutritional content of the bars was measured.

| Item Name | | | | | | | | |
|---|---|---|---|---|---|---|---|---|
| Owen's Nutrition Bars (10 bars) | Quantity | Measure | Wgt (g) | Cals (kcal) | FatCals (kcal) | SatCals (kcal) | Prot (g) | Carb (g) |
| Sugar | 0.2 | Cup | 28.80 | 96.00 | 0 | 0 | 0 | 28.80 |
| Cocoa, natural, pwd | 0.3 | Tablespoon | 1.50 | 4.50 | 2.70 | 0 | 0.30 | 0.60 |
| Butter, salted | 0.05 | Cup | 11.36 | 81.45 | 81.45 | 52.52 | 0.10 | 0.01 |
| Milk, 2% | 0.05 | Cup | 12.30 | 6.15 | 2.19 | 1.39 | 0.41 | 0.59 |
| Nut Butter, peanut, | 0.05 | Cup | 12.80 | 76.00 | 57.60 | 10.80 | 3.20 | 2.80 |
| creamy | | | | | | | | |
| Honey, clover | 0.2 | Tablespoon | 4.20 | 12.77 | 0 | 0 | 0.03 | 3.40 |
| Cereal, All-Bran | 0.2 | Cup | 12.40 | 32.24 | 5.47 | 0.71 | 1.63 | 9.21 |
| Cereal, granola, | 0.2 | Cup | 16.42 | 63.70 | 8.16 | 1.43 | 1.38 | 13.23 |
| w/raisins, all nat, low fat | | | | | | | | |
| Total | | | 99.78 | 372.81 | 157.57 | 66.86 | 7.04 | 58.63 |

| Item Name | | | | | | | | |
|---|---|---|---|---|---|---|---|---|
| Owen's Nutrition Bars (10 bars) | Fib (g) | SolFib (g) | Sugar (g) | MonSac (g) | Disacc (g) | OCarb (g) | Fat (g) | SatFat (g) |
| Sugar | 0 | 0 | 28.80 | — | — | 0 | 0 | 0 |
| Cocoa, natural, pwd | 0.60 | — | 0 | 0 | 0 | 0 | 0.30 | 0 |
| Butter, salted | 0 | 0 | 0.01 | — | — | 0 | 9.21 | 5.84 |
| Milk, 2% | 0 | 0 | 0.59 | 0.00 | 0.59 | 0 | 0.24 | 0.15 |
| Nut Butter, peanut, | 0.80 | — | 1.20 | — | — | 0.80 | 6.40 | 1.20 |
| creamy | | | | | | | | |
| Honey, clover | 0 | 0 | 3.19 | — | — | 0.21 | 0 | 0 |
| Cereal, All-Bran | 3.63 | — | 1.95 | 0.18 | 1.77 | 3.63 | 0.61 | 0.08 |
| Cereal, granola, | 1.58 | — | 4.21 | — | — | 7.44 | 0.91 | 0.16 |
| w/raisins, all nat, low fat | | | | | | | | |
| Total | 6.61 | 0 | 39.95 | 0.18 | 2.35 | 12.08 | 17.67 | 7.43 |

The bars were analyzed for taste, appearance, texture and flavor. Seventeen volunteers were asked to try the bars and rate the taste, texture, flavor, and appearance on a scale of 1 to 5, with 1 being extreme dislike, 2 being dislike, 3 being okay, 4 being good, and 5 being excellent. The bars had an average rating of 4 for texture, an average rating of 4.5 for flavor, and average rating of 3.6 for appearance, and an overall rating of 4.2. The testers were further asked to evaluate the ease of consuming the entire bar at once. The bars had an average rating of 4.1 for ease of consumption in a single bit.

While various embodiments have been described above, the disclosure is not intended to be limited thereto. Variations can be made to the disclosed embodiments that are still within the scope of the appended aspects.

1. A portable nutrition bar for disseminating information to a target group, comprising:
an edible nutrition bar containing at least ⅓ of the recommend dietary allowance or one or more nutrients, and a wrapper comprising information for selected for the target group, wherein the information is not nutritional information of the edible nutrition bar.

2. The nutrition bar of claim 1, wherein the target group is homeless information.

3. The nutrition bar of claim 2, wherein the information for selected for the target group includes telephone numbers and/or addresses of one or more of shelters, clinics, food-service centers, abuse assistance centers, legal services, and substance abuse assistance centers.

4. The nutrition bar of claim 1, wherein the nutrition bar contains at least ⅓ of the recommended dietary allowance of one or more of calcium, fiber, carbohydrates, protein, fat, vitamin A, vitamin C, vitamin D, vitamin E, vitamin K, vitamin B1 (thiamine), vitamin B2 (riboflavin), vitamin B3 (niacin), pantothenic acid, biotin, vitamin B6, vitamin B12, and folate.

5. The nutrition bar of claim 1, wherein the bars comprises at least ⅓ of the dietary recommended allowance of calories.

6. The nutrition bar of claim 1, wherein the bars are sized to fit in a standard clothing pocket.

7. The nutrition bar of claim 1, wherein the bars have a length of about 1.5 inches to about 5 inches.

8. The nutrition bar of claim 1, wherein the bars have a width of about 1 inch to about 3 inches.

9. A method for disseminating information to a target group, comprising:
selecting a target group;
selecting information for the target group,
providing a portable nutrition bar comprising a wrapper having the selected information printed thereon, and
distributing the portable nutrition bar to the target group.

10. The method of claim 9, wherein the target group is homeless individuals.

11. The method of claim 10, wherein the information comprises telephone numbers and/or addresses of one or more of shelters, clinics, food-service centers, abuse assistance centers, and substance abuse assistance centers.

12. The method of claim 9, wherein the portable nutrition bar provides at least ⅓ of the recommended dietary allowance of one or more nutrients.

13. The method of claim 9, wherein the target group is natural disaster victims.

14. The method of claim 13, wherein the information is for contacting and/or locating one or more emergency service centers, emergency shelters, hospitals, and red cross assistance information.

15. The method of claim 13, wherein the selected information comprises information regarding safe places to be located during a natural disaster.

16. The method of claim 9, wherein the bar comprises at least ⅓ of the dietary recommended allowance of calories.

17. The method of claim 9, wherein the bars are sized to fit in a standard clothing pocket.

18. The method of claim 9, wherein the bars have a length of about 1.5 inches to about 5 inches.

19. The method of claim 9, wherein the bars have a width of about 1 inch to about 3 inches.

20. The method of claim 9, wherein the bars are sized to be consumed in a single bit.
